(19) United States
(12) Patent Application Publication
(10) Pub. No.: US 2002/0156791 A1
(43) Pub. Date: Oct. 24, 2002

(54) Taxonomy of business metrics

(76) Inventors: Diaz Nesamoney, Atherton, CA (US); James Markarian, Belmont, CA (US)

Correspondence Address: WAGNER, MURABITO & HAO LLP, Third Floor, Two North Market Street, San Jose, CA, 95113, US

(21) Appl. No.: 09/838,961

(22) Filed: Apr. 19, 2001

(51) Int. Cl. G06F 7/00

(52) U.S. Cl. 707/100

(57) ABSTRACT

A method and system for organizing data to facilitate access to information defined by an analytic application. In particular, a taxonomy (hierarchy) for organizing the information and data (e.g., business metrics, transformed data, untransformed data, or raw data) is described. The information and data are stored in a repository and categorized in a hierarchical organization navigable by users. A user can select certain instances of the data in the hierarchy to create a customized list containing data of particular interest. Accordingly, access to particular information in the vast amount of information defined by an analytic application is facilitated, and new information of particular interest can be accessed in a timely manner.

### TECHNICAL FIELD

The present invention relates to data management systems. More particularly, the present invention pertains to a method and system for organizing data (e.g., business metrics) defined by an analytic application.

### BACKGROUND ART

Due to the increased amounts of data being stored and processed today, operational databases are constructed, categorized, and formatted for operational efficiency (e.g., throughput, processing speed, and storage capacity). Unfortunately, the raw data found in these operational databases often exist as rows and columns of numbers and code that appear bewildering and incomprehensible to business analysts and decision makers. Furthermore, the scope and vastness of the raw data stored in modern databases render it harder to analyze. Hence, “analytic applications” have been developed in an effort to help interpret, analyze, and compile the data so that it may be more readily understood by a business analyst. These applications map, sort, categorize and summarize the raw data before it is presented for display, so that individuals can interpret the data and use it as the basis for making decisions.

One major difficulty with implementing analytic applications relates to the vast amounts of new data that are continually being generated and added to the operational databases. Frequent refreshes of the information defined by analytic applications are preferred in order to maintain the relevance of the decision-making analyses and to quickly capture the rich data patterns and information contained in the operational databases.

Given the many different types of source data available, and the many ways that the source data can be transformed and combined, large amounts of data are available that can be difficult for a user to navigate. That is, a user may spend a great deal of time searching through databases seeking particular items of information, in particular summary-type information such as the “business metrics” that provide a concise measure of the performance or efficiency of a business (e.g., total sales revenue, margin, etc.). In addition, because the information may change dramatically and/or frequently, a user may need to make such time-consuming searches on a regular basis. Furthermore, a user may not be aware of instances in which information has changed, or changed significantly, and thus may not conduct timely searches of the data. Conversely, the information may not have changed significantly since the last search, and so a user may spend time performing an unnecessary search.

Searching through large databases is made more difficult when the user conducts the search using a device such as a personal digital assistant (PDA), cell phone, or text pager. Relative to a conventional computer system, these types of devices have limited display capability. These types of devices also are relatively limited with respect to their user interface. That is, they lack full size keyboards and other familiar components, and as a result using them to search and move through large databases can be awkward and inefficient.

Similar difficulties are experienced when users try to search through large databases using conventional telephones to interact with an automated voice response system. Although a user can conduct a search using either voice commands or the buttons on a touch-tone phone, a search conducted in this manner is also awkward and inefficient.

Hence, it is desirable to facilitate access to information in the large databases defined by analytic applications, especially items of information of particular interest to a user. It is also desirable for the user to be able to access new information in a timely manner, without requiring the user to conduct frequent and perhaps fruitless searches. Furthermore, it is desirable to accomplish the above using devices such as PDAs, cell phones, text pagers, and conventional telephones. The present invention provides a method and system that meet the above needs.

### SUMMARY OF THE INVENTION

The present invention provides a method and system that can facilitate user access to information in the large databases defined by analytic applications, and that can allow the user to efficiently use his/her time to locate and access information of particular interest. The present invention also provides a method and system that can allow a user to access new information of particular interest in a timely manner. The present invention further provides a method and system that can accomplish these objectives using devices such as PDAs, cell phones, text pagers, and conventional telephones.

A method and system for organizing data to facilitate access to information defined by an analytic application are described. In particular, a taxonomy (hierarchy) for organizing the information and data (e.g., business metrics, transformed data, untransformed data, or raw data) is described. Users can also define their own hierarchies. The information and data are stored in a repository and categorized in a hierarchical organization navigable by users. A user can select certain instances of the data to create a customized list containing data of particular interest.

In one embodiment, termed the “pull” approach, the user can make selections from the customized list to access information of particular interest. The information so identified is provided to the user in response to a user's request.

In another embodiment, termed the “push” approach, information of particular interest can be automatically provided to the user, for example, at a prescribed frequency, when the information changes by a defined amount, or when a certain threshold is reached. Alternatively, an alert can be provided to the user when, for example, the particular information of interest changes by a defined amount.

Thus, in accordance with the present invention, access to particular information in the vast amount of information defined by an analytic application is facilitated, and new information of particular interest can be accessed in a timely manner.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram of an exemplary computer system upon which embodiments of the present invention may be practiced.

FIG. 2 is a block diagram depicting an exemplary system for wireless delivery of data defined by an analytic application in accordance with one embodiment of the present invention.

FIG. 3 illustrates an exemplary hierarchical organization for data defined by an analytic application in accordance with one embodiment of the present invention.

FIG. 4 is a flowchart showing the steps in a process for organizing and accessing data defined by an analytic application in accordance with one embodiment of the present invention.

### DETAILED DESCRIPTION OF THE INVENTION

A system and method for organizing data (e.g., business metrics, transformed data, untransformed data, or raw data) application are described. In particular, a taxonomy of business metrics in an analytic application is described. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

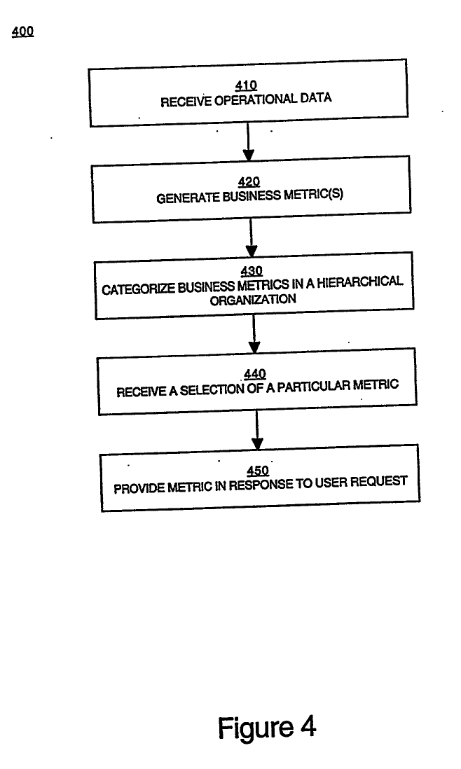

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “generating,” “categorizing,” “receiving,” “sending” or the like, can refer to the actions and processes (e.g., process 400 of FIG. 4) of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices.

Exemplary Computer System Platform

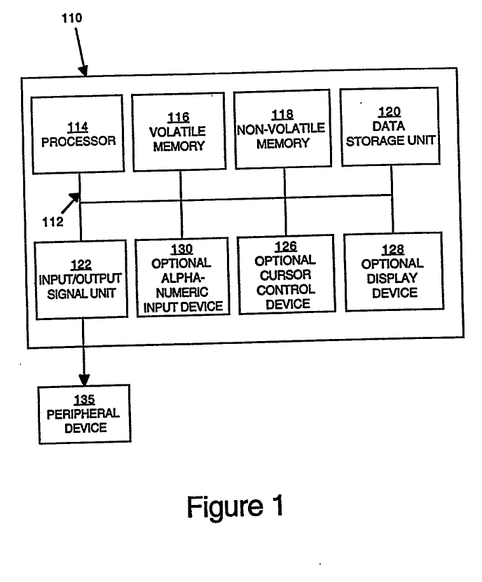

With reference to FIG. 1, portions of the present invention are comprised of the computer-readable and computer-executable instructions that reside, for example, in computer system 110 used as a part of a data warehousing system in accordance with one embodiment of the present invention. It is appreciated that computer system 110 of FIG. 1 is exemplary only and that the present invention can operate within a number of different computer systems including general-purpose computer systems, embedded computer systems, and stand-alone computer systems specially adapted for data warehousing applications.

In the present embodiment, computer system 110 includes an address/data bus 112 for conveying digital information between the various components, a central processor unit (CPU) 114 for processing the digital information and instructions, a volatile main memory 116 comprised of volatile random access memory (RAM) for storing the digital information and instructions, and a non-volatile read only memory (ROM) 118 for storing information and instructions of a more permanent nature. In addition, computer system 110 may also include a data storage unit 120 (e.g., a magnetic, optical, floppy, or tape drive or the like) for storing vast amounts of data. It should be noted that the software program for performing the transport process of the present invention can be stored either in volatile memory 116, data storage unit 120, or in an external storage device (not shown).

Devices which are optionally coupled to computer system 110 include a display device 128 for displaying information to a computer user, an alphanumeric input device 130 (e.g., a keyboard), and a cursor control device 126 (e.g., mouse, trackball, light pen, etc.) for inputting data, selections, updates, etc. Computer system 110 also can include a mechanism for emitting an audible signal (not shown).

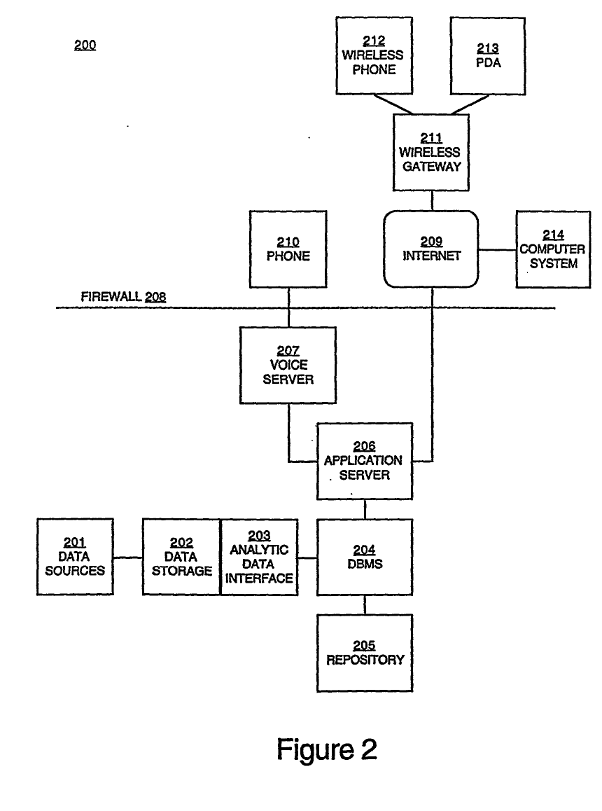

Furthermore, computer system 110 can include an input/output (I/O) signal unit (e.g., interface) 122 for interfacing with a peripheral device 135 (e.g., a computer network, modem, mass storage device, etc.). Accordingly, computer system 110 may be coupled in a network, such as in a client/server environment, whereby a number of clients (e.g., personal computers, workstations, portable computers, minicomputers, terminals, etc.) are used to run processes for performing desired tasks (e.g., inventory control, payroll, billing, etc.). In particular, computer system 110 can be coupled in a system for the delivery of data defined by an analytic application, exemplified by system 200 of FIG. 2, below.

Exemplary Data Delivery System

FIG. 2 illustrates is a block diagram depicting one embodiment of a system 200 for the delivery of data, particularly the wireless delivery of data, in accordance with the present invention. Data sources 201 include one or more sources of operational data resulting from business and financial transactions, equipment performance logs, and the like. These data sources can based on and formatted according to a Relational Database Management System (RDBMS) (such as from Oracle, Informix, Sybase, Microsoft, etc.), an Enterprise Resource Planning (ERP) system, Service Advertising Protocol (SAP), flat files, and other data transmission formats, either planned or envisioned, including XML, WML, HDML, HTML, and I-mode HTML.

Data storage 202 is for storing operational data and the like from data sources 201, typically using a high capacity mass storage device (such as hard disk drives, optical drives, tape drives, etc.). In one embodiment, data storage 202 is a data warehouse. Data storage 202 is coupled to a database management system (DBMS) 204 by analytic data interface 203. DBMS 204 executes an analytic application such as a data mart application. A repository 205 is coupled to (or integrated with) DBMS 204 for storing information from the database management system.

In one embodiment, data are generated using a process such as the Transformation Definition Language (TDL) process described in U.S. Pat. No. 6,014,670, assigned to the assignee of the present invention and hereby incorporated by reference. There are at least three styles of calculating data (e.g., business metrics): periodic, on demand, and continuous (real time). In the periodic style, data are calculated at predetermined intervals (e.g., hourly, daily, weekly, etc.) and stored in repository 205, and the most recent data are provided to the requester. In the on demand style, the data are calculated in response to a user request. These data may be cached or persisted in some manner (e.g., in repository 205), but do not exist or have value until they are initially requested. In the continuous (real time) style, data are updated as underlying data are updated. For example, a business metric describing the moving average for the inventory of a particular item gets updated as the inventory level for that item is updated. In each case, the requester gets the freshest data.

It is appreciated that business metrics can include any number of either the commonly used metrics for measuring business performance and efficiency, or unique business metrics defined by a user of an analytic application. Business metrics include, but are not limited to, measures of account receivables, account payables, general ledger, and cash flow. Metrics for account receivables can include, but are not limited to: account receivable balances, account receivable transactions, quality of sales, receivables-to-sales ratio, average collection period, customer credit reports, days outstanding, ratio of cash receipts to billed sales and payments in progress, ratio between ending accounts receivables balance and sum of billed sales, progress payments and beginning balances, ratio of ending receivables balance to cash receipts, account receivables turnover, average receivables amount, aging receivables by period, day of sales in receivables ratio, and current period collection rate. Metrics for account payables can include, but are not limited to: account payables balances, account payables transactions, quality of purchase, account payables turnover ratio, disbursements-to-payables ratio, days outstanding, payables-to-purchase ratio, average payment period, vendor credit analysis, ratio of cash disbursements to invoiced receipts, ratio between ending accounts payables balance and sum of incoming invoiced amounts, progress payments and beginning balances, ratio of ending payables balance to cash disbursements, payables-to-sales ratio, average payables amount, aging payables by period, day of purchase in payables ratio, and current period payment rate. General ledger metrics can include, but are not limited to: account balances, balance sheet plus profit/loss statement, revenues, costs, gross margins, and net profits. Cash flow metrics can include, but are not limited to: projected cash flow from receivables, cash flow from operations, and cash on hand.

Returning to FIG. 2, in the present embodiment, an application server 206 is interposed between the DBMS 204 and a voice server 207 or the Internet 209. Application server 206 is exemplified by computer system 110 of FIG. 1. Application server 206 may incorporate DBMS 204 and repository 205, or these may be separate entities.

In one embodiment, application server 206 of FIG. 2 is accessible to users via a unique Uniform Resource Locator (URL). According to either a push or pull approach for data delivery, as described more fully below, application server 206 provides information (e.g., business metrics and transformed data, but also untransformed or raw data) to users from DBMS 204 and/or repository 205.

Voice server 207 provides voice-to-text and text-to-voice services for converting voice messages received from a user via a conventional telephone 210, and for similarly converting information from application server 206 into an audible message. A user can thereby access application server 206 using a conventional telephone 210 via voice server 207, and receive information from application server 206 via the same path. For security purposes, a firewall 208 encloses voice server 207, application server 206 and the other devices and components coupled with those devices on the internal side of the firewall.

Wireless gateway 211 enables communication between wireless devices and application server 206 within the framework of a wireless service provider (WSP). Wireless devices are exemplified as wireless phone 212 and PDA 213; however, it is appreciated that other types of wireless devices such as a pager or two-way pager, or any other data-capable or data-enabled device operable for wireless communication, may be used. Preferably, the wireless devices have display capability, but other means for conveying information to a user may be utilized. For example, information can be converted into an audible message (e.g., text-to-voice) as part of an automated voice response system.

Coupled to the Internet 209 may be a computer system 214 that is also capable of communicating with application server 206. For example, information can be exchanged between computer system 214 and application server 206 via electronic mail (e-mail). Computer system 214 may also incorporate a Web browser or other such elements allowing it to access a Web site on application server 206 using the URL for application server 206.

In summary, system 200 supports a number of various different types of end-user devices, as well as different types of service providers (e.g., Internet Service Providers, WSPs, etc.). In accordance with the present invention, a user can register a variety of devices and device types utilizing different service providers, protocols, communication standards, and data formats, and use these devices to receive information (e.g., business metrics, etc.) at remote locations (e.g., at field locations worldwide).

Taxonomy of Information Defined by Analytic Applications

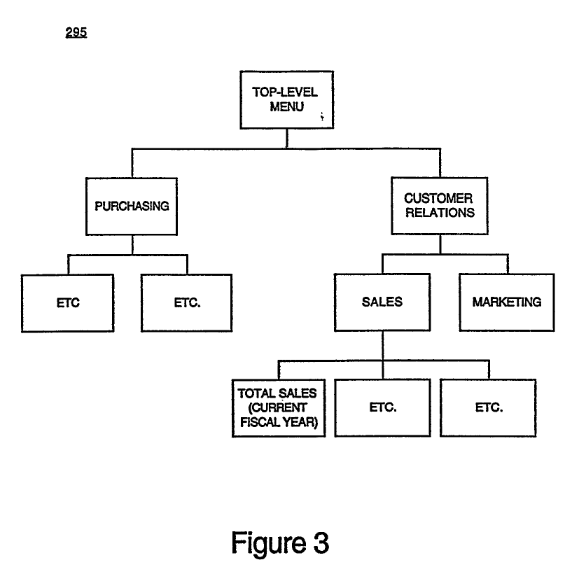

FIG. 3 illustrates an exemplary hierarchical organization 295 (e.g., a taxonomy) used to organize data (e.g., business metrics, transformed data, untransformed data, or raw data) and information defined by an analytic application in accordance with one embodiment of the present invention. In one embodiment, the hierarchical organization 295 is applied to the information stored in a database (e.g., repository 205 of FIG. 2). In another embodiment, the hierarchical organization 295 is applied to a taxonomy of business metrics, transformed data, untransformed data, or raw data. That is, as described above, there are at least three styles for calculating business metrics: periodic, on demand, and continues (real time). Thus, hierarchical organization 295 can be used to navigate through calculated data stored in repository 205, or it can be used to navigate through a taxonomy of data that are not processed until the user makes a request for a particular instance of data.

In one embodiment, a user accessing hierarchical organization 295 is presented with a top-level menu. As described above, the user can accomplish this using a PDA, a cell phone, a text pager, a conventional telephone, a conventional desktop computer system, or any other data-capable or data-enabled device operable for wireless communication.

In accordance with the present invention, the user can navigate through hierarchical organization 295 by selecting an item from the top-level menu (e.g., either “purchasing” or “customer relations”), and then by making further selections at each subsequent level in hierarchical organization 295. For example, after selecting “customer relations,” a user can then select “sales” or “marketing.” A user can move backwards or forwards (up or down) in hierarchical organization 295; that is, from “customer relations,” a user can move to the top-level menu or to either “sales” or “marketing.”

In one embodiment, hierarchical organization 295 is a standardized (or fixed) taxonomy defined by an administrator of system 200 (FIG. 2), for example. In another embodiment, hierarchical organization 295 is customized by and/or for each user. In the latter embodiment, each user selects information (e.g., business metrics, transformed data, untransformed data, or raw data) of particular interest and creates their own unique taxonomies. For example, a user can select “total sales (current fiscal year)” from hierarchical organization 295 and include this in a user-specific taxonomy. Consequently, the user does not need to subsequently navigate through hierarchical organization 295 to access this information, and instead can access this information directly in the user-specific taxonomy. The present invention thus provides a method and system that can facilitate user access to information (e.g., business metrics, transformed data, untransformed data, or raw data) defined by an analytic application, and that can allow the user to efficiently use his/her time to locate and access information of particular interest.

It is appreciated that hierarchical organization 295 can be arbitrarily deep or broad (e.g., any number of levels, and any number of entries at each level), and that multiple different taxonomies can be associated with a single analytic application. Thus, different types of users can each use independent taxonomies; for example, a first taxonomy may be specifically designed for a particular job function, and a second taxonomy for another job function. In addition, one hierarchical organization 295 may refer to another (e.g., a node in one taxonomy may be linked to a node in another).

It is also appreciated that, although in the preferred embodiment the information in hierarchical organization 295 pertains to information defined by an analytic application (e.g., business metrics, transformed data, untransformed data, or raw data), the present invention can also be used for unstructured data such as news feeds and the like.

It is further appreciated that, although hierarchical organization 295 is shown in FIG. 3 as having one “parent” for each entry in a level, in fact there may be multiple parents for an entry. That is, “total sales” is shown as depending from “sales;” in actuality, “total sales” may depend from many other parents, and in turn may be the parent for multiple entries at a lower level in hierarchical organization 295. Thus, in accordance with the present invention, a user may operate further on information found through navigation of hierarchical organization 295. That is, a user may reach a particular business metric by following one “path” through hierarchical organization 295, but can leave that business metric by a different path, either back up hierarchical organization 295 or to a level deeper in hierarchical organization 295.

In one embodiment, the information in hierarchical organization 295 is provided in response to user-initiated actions (termed a “pull” approach). That is, the user can navigate through hierarchical organization 295, select an item of information, and be provided with data in response to the selection.

In another embodiment (termed a “push” approach), a user can instead specify a frequency with which to receive data (e.g., business metrics) of interest; the information is provided to the user at the frequency specified (e.g., hourly, daily, weekly, etc.). In another embodiment of the push approach, a user can specify that data (e.g., business metrics) of interest are to be displayed when they change from a previous value. In this embodiment, the user can also specify thresholds or conditions under which they should be notified of a change in the data of interest. For example, the user can specify that if a metric changes by a certain amount, or by a certain percentage, then that metric should be provided. Similarly, in another embodiment, the user can be alerted to a significant change in the data of interest. That is, instead of the metric being displayed, an audio or visual signal detectable by the user can be made.

The present invention thus provides a method and system that can allow a user to access new information of particular interest in a timely manner, without the user having to continually check to see if the information has changed significantly. The hierarchical organization 295 particularly lends itself to wireless access. The capability for a user to input instructions using a wireless device (e.g., wireless phone 212 and PDA 213 of FIG. 2, or a similar type of device) may be limited in comparison to a conventional computer system. The amount of data that can be sent to a wireless device may also be comparatively limited, and the amount of time that a user can remain connected to application server 206 (FIG. 2) may be limited as well. However, in accordance with the present invention, a user can more readily locate and access particular information of interest defined by an analytic application, and as such the present invention makes remote (wireless) access a viable alternative.

The present invention also provides a framework for the delivery of information (e.g., business metrics) via an automated voice response system. The user can request data using voice commands or by naming each level in hierarchical organization 295 until the user reaches the point in the taxonomy of interest. Furthermore, the taxonomy can be read to the user utilizing a text-to-speech system, thereby allowing the user to receive data even if the user is not familiar with the taxonomy of hierarchical organization 295.

Additional information regarding wireless delivery of business metrics, the push approach, and the pull approach is provided in the co-pending U.S. patent application entitled “Method and System for the Wireless Delivery of Transformed Data,” Attorney Docket Number INFO-P010, with Ser. No. _______ and filing date _______,assigned to the assignee of the present invention and hereby incorporated by reference.

FIG. 4 is a flowchart showing the steps in a process 400 for organizing and accessing data (including business metrics, transformed data, untransformed data, and raw data) defined by an analytic application in accordance with one embodiment of the present invention. Process 400 can be implemented via computer-readable program instructions stored in a memory unit (e.g., volatile memory 116, non-volatile memory 118, and/or data storage unit 120) and executed by processor 114 of computer system 110 (FIG. 1). However, it is appreciated that portions of process 400 can be implemented on different computer systems that are communicatively linked in a computer system network. It is also understood that each of the steps in process 400 are optional depending on the particular information needs of the user. In addition, it is understood that the steps in process 400 can be performed in a different order, or that they can be repeated as necessary.

In step 410 of FIG. 4, in the present embodiment, operational data are received from a source (e.g., data sources 201 of FIG. 2).

In step 420 of FIG. 4, metrics are generated using an analytic application such as the TDL process described in the above-referenced US Pat. No. 6,014,670. As described above, there are at least three styles of data and data generation: periodic, on demand, and continuous (real time). The metrics may be generated dynamically, in which case they can be provided to a user without being stored in a database, for example. Alternatively, the metrics may be generated and stored in a database (e.g., repository 205 of FIG. 2).

In step 430 of FIG. 4, in the present embodiment, information defined by an analytic application is categorized according to a hierarchical organization (taxonomy) such as that shown by FIG. 3. The hierarchical organization can be defined by the user, or by the designer or administrator of system 200. The hierarchical organization can also be established automatically by grouping similar types of data (e.g., account receivables, account payables, etc.), or by grouping the data by vendor, customer, department or the like.

In step 440 of FIG. 4, in one embodiment, a user can subsequently select one or more of the instances of information using hierarchical organization 295. As described above in step 420, the data corresponding to the user's selection can be retrieved from repository 205 if the data exist, or the data can be generated in response to the user's selection.

In step 450 of FIG. 4, data responsive to the user's selection are transmitted to the user's device (e.g., telephone 210, wireless phone 212, PDA 213 or computer system 214 of FIG. 2).

In summary, the present invention provides a method and system that can facilitate user access to information in the large databases defined by analytic applications, and that can allow the user to efficiently use his/her time to locate and access information of particular interest. The present invention also provides a method and system that can allow a user to access new information of particular interest in a timely manner. The present invention further provides a method and system that can accomplish these objectives using devices such as PDAs, cell phones, text pagers, and conventional telephones.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modification as are suited to the particular use contemplated. It is intended that the scope of the invention be defined by the claims appended hereto and their equivalents.

What is claimed is:

1. A method for facilitating access to information defined by an analytic application, said method comprising the computer-implemented steps of:
a) receiving operational data from a data source;
b) generating metrics from said operational data using said analytic application;
c) categorizing said metrics in a hierarchical organization navigable by a user;
d) receiving from a user a first selection identifying an instance of said metrics; and
e) sending said instance of said metrics to said user.

2. The method as recited in claim 1 wherein said hierarchical organization is user-specific.

3. The method as recited in claim 1 wherein said hierarchical organization is linked to another hierarchical organization.

4. The method as recited in claim 1 wherein said metric is sent to a wireless device.

5. The method as recited in claim 1 further comprising the step of:
receiving registration information from a user, said registration information specifying an approach for delivery of data.

6. The method as recited in claim 5 wherein said approach is characterized as a data pull approach wherein said step e) is performed in response to an initiating request from said user.

7. The method as recited in claim 5 wherein said approach is characterized as a data push approach wherein said step e) is performed automatically in response to a predefined requirement being met.

8. The method as recited in claim 1 wherein said step b) is performed on a periodic basis at predetermined intervals.

9. The method as recited in claim 1 wherein said step b) is performed in response to an initiating request from a user.

10. The method as recited in claim 1 wherein said step b) is performed automatically as an instance of data used for generating a particular metric is updated.

11. A computer system comprising:
a bus;
a memory unit coupled to said bus; and
a processor coupled to said bus, said processor for executing a method for facilitating access to information defined by an analytic application, said method comprising the steps of:
a) receiving operational data from a data source;
b) generating metrics from said operational data using said analytic application;
c) categorizing said metrics in a hierarchical organization navigable by a user;
d) receiving from a user a first selection identifying an instance of said metrics; and
e) sending said instance of said metrics to said user.

12. The computer system of claim 11 wherein said hierarchical organization is user-specific.

13. The computer system of claim 11 wherein said hierarchical organization is linked to another hierarchical organization.

14. The computer system of claim 11 wherein said metric is sent to a wireless device.

15. The computer system of claim 11 wherein said method further comprises the step of:
receiving registration information from a user, said registration information specifying an approach for delivery of data.

16. The computer system of claim 15 wherein said approach is characterized as a data pull approach wherein said step e) of said method is performed in response to an initiating request from said user.

17. The computer system of claim 15 wherein said approach is characterized as a data pull approach wherein said step e) of said method is performed automatically in response to a predefined requirement being met.

18. The computer system of claim 11 wherein step b) of said method is performed on a periodic basis at predetermined intervals.

19. The computer system of claim 11 wherein step b) of said method is performed in response to an initiating request from a user.

20. The computer system of claim 11 wherein step b) of said method is performed automatically as an instance of data used for generating a value for a particular metric is updated.

21. A computer-usable medium having computer-readable program code embodied therein for causing a computer system to perform the steps of:
a) receiving operational data from a data source;
b) generating metrics from said operational data using an analytic application;
c) categorizing said metrics in a hierarchical organization navigable by a user;
d) receiving from a user a first selection identifying an instance of said metrics; and
e) sending said instance of said metrics to said user.

22. The computer-usable medium of claim 21 wherein said hierarchical organization is user-specific.

23. The computer-usable medium of claim 21 wherein said hierarchical organization is linked to another hierarchical organization.

24. The computer-usable medium of claim 21 wherein said metric is sent to a wireless device.

25. The computer-usable medium of claim 21 wherein said computer-readable program code embodied therein causes a computer system to perform the step of:
receiving registration information from a user, said registration information specifying an approach for delivery of data.

26. The computer-usable medium of claim 25 wherein said approach is characterized as a data pull approach wherein said step e) is performed in response to an initiating request from said user.

27. The computer-usable medium of claim 25 wherein said approach is characterized as a data push approach wherein said step e) is performed automatically in response to a predefined requirement being met.

28. The computer-usable medium of claim 21 wherein said step b) is performed on a periodic basis at predetermined intervals.

29. The computer-usable medium of claim 21 wherein said step b) is performed in response to an initiating request from a user.

30. The computer-usable medium of claim 21 wherein said step b) is performed automatically as an instance of data used for generating a particular metric is updated.
